(19) United States
(12) Patent Application Publication
(10) Pub. No.: US 2024/0218298 A1
(43) Pub. Date: Jul. 4, 2024

(54) CLEANING COMPOSITIONS AND METHODS OF USE THEREOF FOR STARCH AND FATS

(71) Applicant: ECOLAB USA INC., Saint Paul, MN (US)

(72) Inventors: Erik C. Olson, Saint Paul, MN (US); Rosalind Haas, Saint Paul, MN (US); Jesse Ray Murphy, Saint Paul, MN (US); Derrick Anderson, Saint Paul, MN (US); Erin Jane Dahlquist Howlett, Saint Paul, MN (US); Jesus Cabanas, Saint Paul, MN (US); Hyemi Jo, Seoul (KR)

(21) Appl. No.: 18/541,640

(22) Filed: Dec. 15, 2023

Related U.S. Application Data
(60) Provisional application No. 63/387,564, filed on Dec. 15, 2022.

(51) Int. Cl. C11D 3/386

(52) U.S. Cl. CPC C11D 3/38618; C11D 2111/12; C11D 2111/44

(57) ABSTRACT

Compositions and methods for removing tenacious soils from surfaces are disclosed Compositions and methods for an enzymatic cleaning composition particularly well suited for starch and oil removal, including rice starch and chili oil, are disclosed. The methods include use of a liquid presoak cleaning composition comprising an amylase enzyme, at least one surfactant, buffer, water, and optional additional functional ingredients.

### CROSS-REFERENCE TO RELATED APPLICATIONS

This application claims priority under 35 U.S.C. § 119 to provisional application Ser. No. 63/387,564, filed Dec. 15, 2022, herein incorporated by reference in its entirety.

### TECHNICAL FIELD

The disclosure relates generally to compositions and methods for removing tenacious soils from surfaces. Compositions and methods for an enzymatic cleaning composition particularly well suited for starch and oil (i.e. fat) removal, including rice starch and chili oil, are disclosed. More particularly, the methods provide a liquid presoak cleaning composition comprising a stabilized amylase enzyme for the degradation of starch, at least one surfactant for the removal of oils and other soils, buffer, water, and optional additional functional ingredients.

### BACKGROUND

A key objective to be solved by institutional ware washing products is dealing with tenacious and difficult to remove food soils on wares, including tableware, for example. As an example, the removal of starch containing soils, such as rice starches and oils, such as chili oil, presents a major challenge for effective soil removal. Failure to remove such soils can result in layers forming on the ware and creating an even greater challenge to remove both new and baked on soils.

Various state of the art ware washing products have the objective of starch removal through use of highly caustic or alkaline detergents. These various detergent products must be able to wet, emulsify, suspend, penetrate, and disperse soils. They must also prevent the built-up of starch layers. Other techniques to improve detergency have included using a highly alkaline solution and/or acid solutions applied directly onto the ware. In still other techniques, ware washing products have employed enzymes to enhance detergency.

Enzymes have been employed in cleaning compositions since early 20^{th} century. However, it was not until the mid-1960's when enzymes were commercially available with both the pH stability and soil reactivity for detergent applications. Enzymes are known as effective chemicals for use with detergents and other cleaning agents to break down soils. Enzymes break down soils, make them more soluble, and enable surfactants to remove them from a surface to provide enhanced cleaning of a substrate.

Specifically, enzymes can provide desirable activity for removal of, for example, protein-based, carbohydrate-based, or triglyceride-based stains from substrates. As a result, enzymes have been used for various cleaning applications in order to digest or degrade soils such as grease, oil, protein, carbohydrate, or the like. Although products containing enzymes have evolved from simple powders containing alkaline protease to more complex granular compositions containing multiple enzymes and still further to liquid compositions, there remains a need for alternative cleaning applications employing stabilized enzymes in combination with other components providing effective detergency.

Still many enzymatic cleaning compositions employ enzymes in powder form. This can present safety challenges due to inhalation risk when dispensing powders into a cleaning vessel for use. Therefore, it remains a need to replace powder cleaning compositions containing enzymes.

Accordingly, there remains a need in the art for more efficacious removal of soils, including for the unique combination of starches and oils, namely rice starches and chili oil.

It is therefore an object of this disclosure to provide a liquid composition comprising an enzyme, surfactants and additional functional ingredients to provide efficacious detergency for soil removal, including starches and oils.

It is a further object of the disclosure to provide concentrated liquid compositions to provide a desired use pH for liquid composition comprising an enzyme, surfactants and additional functional ingredients to provide efficacious detergency for soil removal, including starches and oils.

It is another object of this disclosure to provide methods for cleaning, including presoak methods using the liquid cleaning composition to provide efficacious detergency for soil removal, including starches and oils.

It is an objective to develop methods for use of the stabilized enzymes in the liquid cleaning compositions and in use solutions therefore for improved detergency for soil removal, including starches and oils.

Other objects, embodiments and advantages of this disclosure will be apparent to one skilled in the art in view of the following disclosure, the drawings, and the appended claims.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part. It is a primary object, feature, and/or advantage of the present disclosure to improve on or overcome the deficiencies in the art.

It is a further object, feature, and/or advantage of the present disclosure to provide liquid cleaning compositions comprising enzymes and surfactants to provide efficacious detergency.

It is still yet a further object, feature, and/or advantage of the present disclosure to methods of using the liquid cleaning compositions for efficacious detergency in a number of applications of use. The liquid cleaning compositions are beneficially formulated to provide the combined use of amylase enzymes and surfactants to provide both beneficial detergency for removal of tenacious starch and fat soils, namely rice starch and chili oil.

According to some aspects of the present disclosure, liquid cleaning compositions comprise: an amylase enzyme; at least one surfactant; a buffer; and water, wherein the liquid composition is a concentrate having a pH from about 4 to about 11.

According to some additional aspects of the present disclosure, a method of using the liquid cleaning composition comprises contacting a ware soiled with starch and fat with the liquid cleaning composition and removing said soils from the ware.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

FIG. 1 is a graph analyzing amylase enzyme stability with a citrate buffer at 6.5 pH and 50° C. over a period of time.

FIG. 2 shows a melamine plate with chili oil used in a chili oil cleaning performance test.

FIG. 3 is a graph analyzing surfactant compatibility of commercially available detergents when combined with amylase enzymes over a period of time.

FIG. 4 is a graph analyzing surfactant compatibility of commercially available detergents and exemplary buffer and amylase enzyme formulas over a period of time.

FIG. 5 is a graph analyzing cleaning performance of an exemplary liquid cleaning composition (formula 3) with varying amounts of amylase enzyme compared to a commercially available detergent over a period of time.

FIG. 6 is a graph analyzing cleaning performance of an exemplary liquid cleaning composition (formula 7) with varying amounts of amylase enzyme compared to a commercially available detergent over a period of time.

Various embodiments of the present disclosure will be described in detail with reference to the drawings, wherein like reference numerals represent like parts throughout the several views. Reference to various embodiments does not limit the scope of the disclosure. Figures represented herein are not limitations to the various embodiments according to the disclosure and are presented for exemplary illustration of the invention. An artisan of ordinary skill in the art need not view, within isolated figure(s), the near infinite number of distinct permutations of features described in the following detailed description to facilitate an understanding of the present invention.

### DETAILED DESCRIPTION

The present disclosure is not to be limited to that described herein, which can vary and are understood by skilled artisans. No features shown or described are essential to permit basic operation of the present disclosure unless otherwise indicated. It has been surprisingly found that the liquid cleaning compositions comprising a stabilized amylase enzyme, at least one surfactant, buffer, water, and optional additional functional ingredients are particularly well suited for starch and oil removal, including rice starch and chili oil.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The methods and compositions of the present disclosure may comprise, consist essentially of, or consist of the components and ingredients of the present disclosure as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

Unless defined otherwise, all technical and scientific terms used above have the same meaning as commonly understood by one of ordinary skill in the art to which embodiments of the present disclosure pertain.

The terms “invention” or “present invention” are not intended to refer to any single embodiment of the particular invention but encompass all possible embodiments as described in the specification and the claims.

The term “about,” as used herein, refers to variation in the numerical quantity that can occur, for example, through typical measuring techniques and equipment, with respect to any quantifiable variable, including, but not limited to, concentration, mass, volume, time, surface tension, molecular weight, temperature, pH, humidity, molar ratios, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thictane, dioxetane, dithietane, dithiete, azolidine, pyrrolidine, pyrroline, oxolane, dihydrofuran, and furan.

As used herein, the term “cleaning” refers to a method used to facilitate or aid in soil removal, bleaching, microbial population reduction, and any combination thereof. As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

As used herein, the term “exemplary” refers to an example, an instance, or an illustration, and does not indicate a most preferred embodiment unless otherwise stated.

As used herein, the phrase “food processing surface” refers to a surface of a tool, a machine, equipment, a structure, a building, or the like that is employed as part of a food processing, preparation, or storage activity. Examples of food processing surfaces include surfaces of food processing or preparation equipment (e.g., slicing, canning, or transport equipment, including flumes), of food processing wares (e.g., utensils, dishware, wash ware, and bar glasses), and of floors, walls, or fixtures of structures in which food processing occurs. Food processing surfaces are found and employed in food anti-spoilage air circulation systems, aseptic packaging sanitizing, food refrigeration and cooler cleaners and sanitizers, ware washing sanitizing, blancher cleaning and sanitizing, food packaging materials, cutting board additives, third-sink sanitizing, beverage chillers and warmers, meat chilling or scalding waters, autodish sanitizers, sanitizing gels, cooling towers, food processing antimicrobial garment sprays, and non-to-low-aqueous food preparation lubricants, oils, and rinse additives.

The term “generally” encompasses both “about” and “substantially.”

The term “hard surface” refers to a solid, substantially non-flexible surface such as a counter top, tile, floor, wall, panel, window, plumbing fixture, kitchen and bathroom furniture, appliance, engine, circuit board, dish, mirror, window, monitor, touch screen, and thermostat. Hard surfaces are not limited by the material; for example, a hard surface can be glass, metal, tile, vinyl, linoleum, composite, wood, plastic, etc. Hard surfaces may include for example, health care surfaces and food processing surfaces.

As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

As used herein, the term “soil” or “stain” refers to any soil, including, but not limited to, non-polar oily and/or hydrophobic substances which may or may not contain particulate matter such as industrial soils, mineral clays, sand, natural mineral matter, carbon black, graphite, kaolin, environmental dust, and/or food based soils such as starchy soils, fatty soils, cellulosic soils, etc.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “substantially” refers to a great or significant extent. “Substantially” can thus refer to a plurality, majority, and/or a supermajority of said quantifiable variable, given proper context.

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

The term “surfactant” or “surface active agent” refers to an organic chemical that when added to a liquid changes the properties of that liquid at a surface.

As used herein, the term “ware” refers to items such as eating and cooking utensils, dishes, and other hard surfaces such as showers, sinks, toilets, bathtubs, countertops, windows, mirrors, transportation vehicles, and floors. As used herein, the term “warewashing” refers to washing, cleaning, or rinsing ware. Ware also refers to items made of plastic. Types of plastics that can be cleaned with the compositions include but are not limited to, those that include polypropylene polymers (PP), polycarbonate polymers (PC), melamine formaldehyde resins or melamine resin (melamine), acrylonitrile-butadiene-styrene polymers (ABS), and polysulfone polymers (PS). Other exemplary plastics that can be cleaned using the compounds and compositions of the disclosure include polyethylene terephthalate (PET) polystyrene polyamide.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

### Cleaning Compositions

According to embodiments, the liquid cleaning compositions include an amylase enzyme, at least one surfactant, buffer and water. The liquid cleaning compositions can include additional functional ingredients and are provided as a concentrate or use compositions. Exemplary liquid cleaning compositions are shown in Table 1 in weight percentage. While the components may have a percent actives of 100%, it is noted that Table 1 does not recite the percent actives of the components, but rather, recites the total weight percentage of the raw materials (i.e. active concentration plus inert ingredients).

TABLE 1

| | First | Second | Third |
|---|---|---|---|
| | Exemplary | Exemplary | Exemplary |
| Material | Range wt.-% | Range wt.-% | Range wt.-% |
| Amylase enzyme | 0.1-5 | 0.5-5 | 1-5 |
| Surfactant(s) | 2-40 | 2-35 | 2-30 |
| Buffer(s) | 0.5-20 | 0.5-15 | 0.5-10 |
| Water | 30-80 | 40-80 | 45-80 |
| Additional Functional | 0-20 | 0.01-15 | 0.1-10 |
| Ingredients | | | |
| Total | 100 | 100 | 100 |

### Amylase Enzyme

The liquid cleaning composition comprises an amylase enzyme that provides effective starch removal. In some embodiments, the enzyme is supplied in a liquid or solid form and mixed with the other components of the composition, by spraying or mixing.

Enzymes that can be used according to the disclosure include enzymes that provide desirable activity for removal of carbohydrate-based, namely starch-based stains and soils from substrates. In embodiments, the amylase enzyme included for cleaning, destaining, and/or sanitizing presoaks, such as presoaks for flatware, cooking ware, and table ware; or in some alternative embodiments for machine warewashing; and the like.

Although not limiting to the present disclosure, enzymes suitable for the liquid cleaning compositions can act by degrading or altering one or more types of soil residues encountered on an object or surface thus removing the soil or making the soil more removable by a surfactant or other component of the cleaning composition. Both degradation and alteration of soil residues can improve detergency by reducing the physicochemical forces that bind the soil to the object or surface being cleaned, e.g., the soil becomes more water soluble.

An amylase enzyme is included in the liquid cleaning, wherein the amylase enzyme is of any suitable origin, such as vegetable, animal, bacterial, fungal or yeast origin. Preferred selections are influenced by factors such as pH-activity and/or stability optima, thermostability, and stability to active detergents, builders and the like. In this respect, bacterial or fungal enzymes are preferred, such as bacterial amylases and proteases, and fungal cellulases. In some embodiments the amylase enzyme is further combined with a mixture of amylases or in combination with an additional enzyme.

In preferred embodiments, amylase enzymes can be derived from a plant, an animal, or a microorganism. The amylase may be derived from a microorganism, such as a yeast, a mold, or a bacterium. Exemplary amylases include those derived from a Bacillus, such as B. licheniformis, B. amyloliquefaciens, B. subtilis, or B. stearothermophilus. The amylase can be purified or a component of a microbial extract, and either wild type or variant (either chemical or recombinant). Exemplary amylase enzymes include those sold under the trade name Rapidase by Gist-Brocades® (Netherlands); those sold under the trade names Termamyl®, Fungamyl® or Duramyl® by Novo; those sold under the trade names Purastar STL or Purastar OXAM by Genencor; those sold under the trade names Achieve® Shine or Stainzyme® by Novozymes; those sold under the trade names Thermozyme® L340 or Deterzyme® PAG 510/220 by Deerland Corporation; and the like.

An amylase enzyme can generally provide optimum activity at a pH range of from about 4 to 9. In an embodiment, the amylase included in the liquid cleaning composition is selected for enhanced soil removal at a pH of from about 4 to 9, about 5 to 9, and preferably about 6.

In some embodiments, the enzyme is included in the composition at an amount of at least about 0.1 wt-% to about 10 wt-%, about 0.1 wt-% to about 5 wt-%, about 0.5 wt-% to about 5 wt-%, about 1 wt-% to about 5 wt-%, or about 2 wt-% to about 5 wt-%. In addition, without being limited according to the disclosure, all ranges recited are inclusive of the numbers defining the range and include each integer within the defined range.

Beneficially, as a result of superior stabilization of enzymes in the liquid cleaning compositions of the present disclosure, the composition can effectively lower the concentration of enzymes and/or exclude the use of other conventional enzyme stabilizers or ingredients commonly found in existing liquid and/or solid cleaning compositions employing enzymes. There are various reasons to beneficially reduce or remove use of enzyme stabilizers, including formulation challenges or health/safety/labeling concerns in a concentrated composition (e.g. GHS label icon warnings that are not desired). At a minimum stabilizers add complexity to a formula and take up “formulation space” for other functional ingredients. Accordingly, it is an advantage of using the disclosed liquid cleaning compositions with stabilized enzymes with no or a reduced amount of other stabilizers.

### Surfactants

The liquid cleaning composition comprises at least one surfactant for efficacious detergency, including the removal of tenacious fat oils and other soils. Preferred surfactants include amphoteric surfactants and/or nonionic surfactants.

In some embodiments the surfactant includes surfactant can be selected from the group amine oxides, alkyl polyglycosides, EO/PO block copolymers, alcohol ethoxylates, alkyl phenol ethoxylates, polyethylene glycol esters, aminoxides, linear alkyl benzene sulfonates, alcohol sulfonates, alkylbenzensulfonates, sodium laurylethersulfates and mixtures thereof. In preferred embodiments the surfactant is selected from the group of amine oxides, alkyl polyglycosides, EO/PO block copolymers, and mixtures thereof.

In addition, the level and degree of foaming under the conditions of use may be a factor for selecting particular surfactants and mixtures of surfactants. For example, in certain applications it may be desirable to minimize foaming and a surfactant or mixture of surfactants that provides reduced foaming may be used. In addition, it may be desirable to select a surfactant or a mixture of surfactants that exhibits a foam that breaks down relatively quickly so that the composition may be recovered and reused with an acceptable amount of down time. In addition, the surfactant or mixture of surfactants may be selected depending upon the particular soil that is to be removed.

The surfactants described herein may be used singly or in combination in the liquid cleaning compositions. In particular, the nonionics and amphoterics may be used in combination. In addition, in some embodiments semi-polar nonionic, cationic, anionic and zwitterionic surfactants may be employed in combination with nonionics and/or amphoterics. The above examples are merely specific illustrations of the numerous surfactants which may find application within the scope of this invention. It should be understood that the selection of particular surfactants or combinations of surfactants may be based on a number of factors including compatibility with the surface to be cleaned at the intended use concentration and the intended environmental conditions including temperature and pH.

Useful nonionic surfactants are generally characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Practically any hydrophobic compound having a hydroxyl, carboxyl, amino, or amido group with a reactive hydrogen atom can be condensed with ethylene oxide, or its polyhydration adducts, or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water soluble compound having the desired degree of balance between hydrophilic and hydrophobic properties.

Nonionic surfactants include, but are not limited to, those having a polyalkylene oxide polymer as a portion of the surfactant molecule. Exemplary nonionic surfactants include, but are not limited to, chlorine-, benzyl-, methyl-, ethyl-, propyl-, butyl- and other like alkyl-capped polyethylene and/or polypropylene glycol ethers of fatty alcohols; polyalkylene oxide free nonionics such as alkyl polyglycosides; sorbitan and sucrose esters and their ethoxylates; alkoxylated ethylene diamine; carboxylic acid esters such as glycerol esters, polyoxyethylene esters, ethoxylated and glycol esters of fatty acids; carboxylic amides such as diethanolamine condensates, monoalkanolamine condensates, polyoxyethylene fatty acid amides; and ethoxylated amines and ether amines commercially available from Tomah Corporation and other like nonionic compounds. Silicone surfactants such as the ABIL B8852 (Goldschmidt) may also be used.

Additional exemplary nonionic surfactants include, but are not limited to, those having a polyalkylene oxide polymer portion include nonionic surfactants of C6-C24 alcohol ethoxylates, preferably C6-C14 alcohol ethoxylates having 1 to about 20 ethylene oxide groups, preferably about 9 to about 20 ethylene oxide groups; C6-C24 alkylphenol ethoxylates, preferably C8-C10 alkylphenol ethoxylates) having 1 to about 100 ethylene oxide groups, preferably about 12 to about 20 ethylene oxide groups; C6-C24 alkylpolyglycosides, preferably C6-C20 alkylpolyglycosides, having 1 to about 20 glycoside groups, preferably about 9 to about 20 glycoside groups; C6-C24 fatty acid ester ethoxylates, propoxylates or glycerides; C12-C14 secondary alcohols and C4-C24 mono or dialkanolamides.

Exemplary alcohol alkoxylates include, but are not limited to, alcohol ethoxylate propoxylates, alcohol propoxylates, alcohol propoxylate ethoxylate propoxylates, alcohol ethoxylate butoxylates; nonylphenol ethoxylate, polyoxyethylene glycol ethers; and polyalkylene oxide block copolymers including an ethylene oxide/propylene oxide block copolymer such as those commercially available under the trademark PLURONIC (BASF-Wyandotte).

Examples of suitable low foaming nonionic surfactants also include, but are not limited to, secondary ethoxylates, such as those sold under the trade name TERGITOL™, such as TERGITOL™ 15-S-7 (Union Carbide), Tergitol 15-S-3, Tergitol 15-S-9 and the like. Other suitable classes of low foaming nonionic surfactants include alkyl or benzyl-capped polyoxyalkylene derivatives and polyoxyethylene/polyoxypropylene copolymers.

An additional useful nonionic surfactant is nonylphenol having an average of 12 moles of ethylene oxide condensed thereon, it being end capped with a hydrophobic portion including an average of 30 moles of propylene oxide. Silicon-containing defoamers are also well-known and may be employed.

Block polyoxypropylene-polyoxyethylene polymeric compounds based upon propylene glycol, ethylene glycol, glycerol, trimethylolpropane, and ethylenediamine as the initiator reactive hydrogen compound. Examples of polymeric compounds made from a sequential propoxylation and ethoxylation of initiator are commercially available from BASF Corp. One class of compounds are difunctional (two reactive hydrogens) compounds formed by condensing ethylene oxide with a hydrophobic base formed by the addition of propylene oxide to the two hydroxyl groups of propylene glycol. This hydrophobic portion of the molecule weighs from about 1,000 to about 4,000. Ethylene oxide is then added to sandwich this hydrophobe between hydrophilic groups, controlled by length to constitute from about 10% by weight to about 80% by weight of the final molecule. Another class of compounds are tetra-flinctional block copolymers derived from the sequential addition of propylene oxide and ethylene oxide to ethylenediamine. The molecular weight of the propylene oxide hydrotype ranges from about 500 to about 7,000; and, the hydrophile, ethylene oxide, is added to constitute from about 10% by weight to about 80% by weight of the molecule.

Condensation products of one mole of alkyl phenol wherein the alkyl chain, of straight chain or branched chain configuration, or of single or dual alkyl constituent, contains from about 8 to about 18 carbon atoms with from about 3 to about 50 moles of ethylene oxide. The alkyl group can, for example, be represented by diisobutylene, di-amyl, polymerized propylene, iso-octyl, nonyl, and di-nonyl. These surfactants can be polyethylene, polypropylene, and polybutylene oxide condensates of alkyl phenols. Examples of commercial compounds of this chemistry are available on the market under the trade names Igepal® manufactured by Rhone-Poulenc and Triton® manufactured by Union Carbide.

Condensation products of one mole of a saturated or unsaturated, straight or branched chain alcohol having from about 6 to about 24 carbon atoms with from about 3 to about 50 moles of ethylene oxide. The alcohol moiety can consist of mixtures of alcohols in the above delineated carbon range or it can consist of an alcohol having a specific number of carbon atoms within this range. Examples of like commercial surfactant are available under the trade names Lutensol™, Dehydol™ manufactured by BASF, Neodol™ manufactured by Shell Chemical Co. and Alfonic™ manufactured by Vista Chemical Co.

Condensation products of one mole of saturated or unsaturated, straight or branched chain carboxylic acid having from about 8 to about 18 carbon atoms with from about 6 to about 50 moles of ethylene oxide. The acid moiety can consist of mixtures of acids in the above defined carbon atoms range or it can consist of an acid having a specific number of carbon atoms within the range. Examples of commercial compounds of this chemistry are available on the market under the trade names Disponil or Agnique manufactured by BASF and Lipopeg™ manufactured by Lipo Chemicals, Inc.

In addition to ethoxylated carboxylic acids, commonly called polyethylene glycol esters, other alkanoic acid esters formed by reaction with glycerides, glycerin, and polyhydric (saccharide or sorbitan/sorbitol) alcohols have application in this disclosure for specialized embodiments, particularly indirect food additive applications. All of these ester moieties have one or more reactive hydrogen sites on their molecule which can undergo further acylation or ethylene oxide (alkoxide) addition to control the hydrophilicity of these substances. Care must be exercised when adding these fatty ester or acylated carbohydrates to compositions of the present disclosure containing amylase and/or lipase enzymes because of potential incompatibility.

Nonionic compounds can be modified, essentially reversed, by adding ethylene oxide to ethylene glycol to provide a hydrophile of designated molecular weight; and, then adding propylene oxide to obtain hydrophobic blocks on the outside (ends) of the molecule. The hydrophobic portion of the molecule weighs from about 1,000 to about 3,100 with the central hydrophile including 10% by weight to about 80% by weight of the final molecule. These reverse Pluronics™ are manufactured by BASF Corporation under the trade name Pluronic™ R surfactants. Likewise, the Tetronic™ R surfactants are produced by BASF Corporation by the sequential addition of ethylene oxide and propylene oxide to ethylenediamine. The hydrophobic portion of the molecule weighs from about 2,100 to about 6,700 with the central hydrophile including 10% by weight to 80% by weight of the final molecule.

Compounds can also be modified by “capping” or “end blocking” the terminal hydroxy group or groups (of multi-functional moieties) to reduce foaming by reaction with a small hydrophobic molecule such as propylene oxide, butylene oxide, benzyl chloride; and, short chain fatty acids, alcohols or alkyl halides containing from 1 to about 5 carbon atoms; and mixtures thereof. Also included are reactants such as thionyl chloride which convert terminal hydroxy groups to a chloride group. Such modifications to the terminal hydroxy group may lead to all-block, block-heteric, heteric-block or all-heteric nonionics.

Additional examples of effective low foaming nonionics include:

The alkylphenoxypolyethoxyalkanols of U.S. Pat. No. 2,903,486 issued Sep. 8, 1959 to Brown et al. and represented by the formula

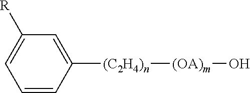

in which R is an alkyl group of 8 to 9 carbon atoms, A is an alkylene chain of 3 to 4 carbon atoms, n is an integer of 7 to 16, and m is an integer of 1 to 10.

The polyalkylene glycol condensates of U.S. Pat. No. 3,048,548 issued Aug. 7, 1962 to Martin et al. having alternating hydrophilic oxyethylene chains and hydrophobic oxypropylene chains where the weight of the terminal hydrophobic chains, the weight of the middle hydrophobic unit and the weight of the linking hydrophilic units each represent about one-third of the condensate.

The defoaming nonionic surfactants disclosed in U.S. Pat. No. 3,382,178 issued May 7, 1968 to Lissant et al. having the general formula Z[(OR)ₙOH]_{z} wherein Z is alkoxylatable material, R is a radical derived from an alkylene oxide which can be ethylene and propylene and n is an integer from, for example, 10 to 2,000 or more and z is an integer determined by the number of reactive oxyalkylatable groups.

The conjugated polyoxyalkylene compounds described in U.S. Pat. No. 2,677,700, issued May 4, 1954 to Jackson et al. corresponding to the formula Y(C₃H₆O)ₙ (C₂H₄O)ₘH wherein Y is the residue of organic compound having from about 1 to 6 carbon atoms and one reactive hydrogen atom, n has an average value of at least about 6.4, as determined by hydroxyl number and m has a value such that the oxyethylene portion constitutes about 10% to about 90% by weight of the molecule.

The conjugated polyoxyalkylene compounds described in U.S. Pat. No. 2,674,619, issued Apr. 6, 1954 to Lundsted et al. having the formula Y[(C₃H₆Oₙ (C₂H₄O)ₘH]ₓ wherein Y is the residue of an organic compound having from about 2 to 6 carbon atoms and containing x reactive hydrogen atoms in which x has a value of at least about 2, n has a value such that the molecular weight of the polyoxypropylene hydrophobic base is at least about 900 and m has value such that the oxyethylene content of the molecule is from about 10% to about 90% by weight. Compounds falling within the scope of the definition for Y include, for example, propylene glycol, glycerin, pentaerythritol, trimethylolpropane, ethylenediamine and the like. The oxypropylene chains optionally, but advantageously, contain small amounts of ethylene oxide and the oxyethylene chains also optionally, but advantageously, contain small amounts of propylene oxide.

Additional conjugated polyoxyalkylene surface-active agents which are advantageously used in the compositions of this disclosure correspond to the formula: P[(C₃H₆O)ₙ(C₂H₄O)ₘH]ₓ wherein P is the residue of an organic compound having from about 8 to 18 carbon atoms and containing x reactive hydrogen atoms in which x has a value of 1 or 2, n has a value such that the molecular weight of the polyoxyethylene portion is at least about 44 and m has a value such that the oxypropylene content of the molecule is from about 10% to about 90% by weight. In either case the oxypropylene chains may contain optionally, but advantageously, small amounts of ethylene oxide and the oxyethylene chains may contain also optionally, but advantageously, small amounts of propylene oxide.

Polyhydroxy fatty acid amide surfactants suitable for use in the present compositions include those having the structural formula R₂CON_{R1}Z in which: R1 is H, C₁-C₄ hydrocarbyl, 2-hydroxy ethyl, 2-hydroxy propyl, ethoxy, propoxy group, or a mixture thereof; R₂ is a C₅-C₃₁ hydrocarbyl, which can be straight-chain; and Z is a polyhydroxyhydrocarbyl having a linear hydrocarbyl chain with at least 3 hydroxyls directly connected to the chain, or an alkoxylated derivative (preferably ethoxylated or propoxylated) thereof. Z can be derived from a reducing sugar in a reductive amination reaction; such as a glycityl moiety.

The alkyl ethoxylate condensation products of aliphatic alcohols with from about 0 to about 25 moles of ethylene oxide are suitable for use in the present compositions. The alkyl chain of the aliphatic alcohol can either be straight or branched, primary or secondary, and generally contains from 6 to 22 carbon atoms.

Suitable surfactants may also include food grade surfactants, linear alkylbenzene sulfonic acids and their salts, and ethylene oxide/propylene oxide derivatives sold under the Pluronic™ trade name. Suitable surfactants include those that are compatible as an indirect or direct food additive or substance.

Suitable nonionic alkylpolysaccharide surfactants, particularly for use in the present compositions include those disclosed in U.S. Pat. No. 4,565,647, Llenado, issued Jan. 21, 1986. These surfactants include a hydrophobic group containing from about 6 to about 30 carbon atoms and a polysaccharide, e.g., a polyglycoside, hydrophilic group containing from about 1.3 to about 10 saccharide units. Any reducing saccharide containing 5 or 6 carbon atoms can be used, e.g., glucose, galactose and galactosyl moieties can be substituted for the glucosyl moieties. (Optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, and/or 6-positions on the preceding saccharide units.

Alkylpolyglycosides and their derivatives are suitable nonionic surfactants for use in the compositions. Alkyl polyglucosides are a type of alkyl polyglycoside derived from a glucose-based polymer. An alkyl polyglucoside, as used herein in this disclosure, is a molecule having one to ten glucose units backbone and at least one alkyl group attached one of the OH groups and has a generic structure of

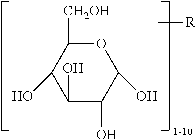

wherein R is an alkyl group and can be attached to any or all of the OH group in the molecule. A cationic alkyl polyglucoside, as used herein in this disclosure, is an alkyl polyglucoside having at least one cationic group in its alkyl group(s). Preferably, the alkyl group has a carbon chain length between about 1 and about 20 carbons, more preferably between about 2 and about 18 carbons, and most preferably between about 4 and about 16 carbons.

Fatty acid amide surfactants suitable for use the present compositions include those having the formula: R₆CON(R₇)₂ in which R₆ is an alkyl group containing from 7 to 21 carbon atoms and each R₇ is independently hydrogen, C₁-C₄ alkyl, C₁-C₄ hydroxyalkyl, or —(C₂H₄O)ₓH, where x is in the range of from 1 to 3.

A useful class of nonionic surfactants include the class defined as alkoxylated amines or, most particularly, alcohol alkoxylated/aminated/alkoxylated surfactants. These non-ionic surfactants may be at least in part represented by the general formulae: R²⁰—(PO)_{S}N—(EO)ₜH, R₂₀—(PO)_{S}N—(EO)ₜH(EO)ₜH, and R²⁰—N(EO)ₜH; in which R²⁰ is an alkyl, alkenyl or other aliphatic group, or an alkyl-aryl group of from 8 to 20, preferably 12 to 14 carbon atoms, EO is oxyethylene, PO is oxypropylene, s is 1 to 20, preferably 2-5, t is 1-10, preferably 2-5, and u is 1-10, preferably 2-5. Other variations on the scope of these compounds may be represented by the alternative formula: R²⁰—(PO)_{V}—N[(EO)_{w}H][(EO)_{z}H] in which R²⁰ is as defined above, v is 1 to 20 (e.g., 1, 2, 3, or 4 (preferably 2)), and w and z are independently 1-10, preferably 2-5. These compounds are represented commercially by a line of products sold by Huntsman Chemicals as nonionic surfactants. A preferred chemical of this class includes Surfonic™ PEA 25 Amine Alkoxylate. Preferred nonionic surfactants for the compositions of the disclosure include alcohol alkoxylates, EO/PO block copolymers, alkylphenol alkoxylates, and the like.

Useful semi-polar nonionic surfactants also include the water soluble phosphine oxides having the following structure:

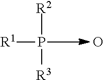

wherein the arrow is a conventional representation of a semi-polar bond; and, R¹ is an alkyl, alkenyl or hydroxyalkyl moiety ranging from 10 to about 24 carbon atoms in chain length; and, R² and R³ are each alkyl moieties separately selected from alkyl or hydroxyalkyl groups containing 1 to 3 carbon atoms. Examples of useful phosphine oxides include dimethyldecylphosphine oxide, dimethyltetradecylphosphine oxide, methylethyltetradecylphosphone oxide, dimethylhexadecylphosphine oxide, diethyl-2-hydroxyoctyldecylphosphine oxide, bis(2-hydroxyethyl)dodecylphosphine oxide, and bis(hydroxymethyl)tetradecylphosphine oxide.

Semi-polar nonionic surfactants useful herein also include the water soluble sulfoxide compounds which have the structure:

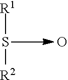

wherein the arrow is a conventional representation of a semi-polar bond; and, R¹ is an alkyl or hydroxyalkyl moiety of about 8 to about 28 carbon atoms, from 0 to about 5 ether linkages and from 0 to about 2 hydroxyl substituents; and R² is an alkyl moiety consisting of alkyl and hydroxyalkyl groups having 1 to 3 carbon atoms. Useful examples of these sulfoxides include dodecyl methyl sulfoxide; 3-hydroxy tridecyl methyl sulfoxide; 3-methoxy tridecyl methyl sulfoxide; and 3-hydroxy-4-dodecoxybutyl methyl sulfoxide.

Semi-polar nonionic surfactants for the compositions of the disclosure include dimethyl amine oxides, such as lauryl dimethyl amine oxide, myristyl dimethyl amine oxide, cetyl dimethyl amine oxide, combinations thereof, and the like. Useful water soluble amine oxide surfactants are selected from the octyl, decyl, dodecyl, isododecyl, coconut, or tallow alkyl di-(lower alkyl) amine oxides, specific examples of which are octyldimethylamine oxide, nonyldimethylamine oxide, decyldimethylamine oxide, undecyldimethylamine oxide, dodecyldimethylamine oxide, iso-dodecyldimethyl amine oxide, tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

Suitable nonionic surfactants suitable for use with the compositions of the present disclosure include alkoxylated surfactants. Suitable alkoxylated surfactants include EO/PO copolymers, capped EO/PO copolymers, alcohol alkoxylates, capped alcohol alkoxylates, mixtures thereof, or the like. Suitable alkoxylated surfactants for use as solvents include EO/PO block copolymers, such as the Pluronic and reverse Pluronic surfactants; alcohol alkoxylates, such as Dehypon LS-54 (R-(EO)₅(PO)₄) and Dehypon LS-36 (R-(EO)₃(PO)₆); and capped alcohol alkoxylates, such as Plurafac LF221 and Tegoten EC11; mixtures thereof, or the like.

Amphoteric surfactants contain both a basic and an acidic hydrophilic group and an organic hydrophobic group. These ionic entities may be any of the anionic or cationic groups described herein for other types of surfactants. A basic nitrogen and an acidic carboxylate group are the typical functional groups employed as the basic and acidic hydrophilic groups. In a few surfactants, sulfonate, sulfate, phosphonate or phosphate provide the negative charge.

Amphoteric surfactants are subdivided into two major classes. The first class includes acyl/dialkyl ethylenediamine derivatives (e.g. 2-alkyl hydroxyethyl imidazoline derivatives) and their salts. The second class includes N-alkylamino acids and their salts. Some amphoteric surfactants can be envisioned as fitting into both classes. Preferred amphoteric surfactants for use in the solid enzymatic compositions can be broadly described as derivatives of aliphatic secondary, tertiary, or quaternary amines, in which the aliphatic radical may be straight chain or branched and wherein one of the aliphatic substituents contains from 6 to 18 carbon atoms and one contains an anionic water solubilizing group, e.g., carboxy, sulfo, sulfato, phosphato, or phosphono. Preferred amphoteric surfactants include amine oxides.

Amine oxides are tertiary amine oxides corresponding to the general formula:

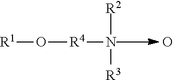

wherein the arrow is a conventional representation of a semi-polar bond; and, R¹, R², and R³ may be aliphatic, aromatic, heterocyclic, alicyclic, or combinations thereof. Generally, for amine oxides of detergent interest, R¹ is an alkyl radical of from about 8 to about 24 carbon atoms; R² and R³ are alkyl or hydroxyalkyl of 1-3 carbon atoms or a mixture thereof; R² and R³ can be attached to each other, e.g. through an oxygen or nitrogen atom, to form a ring structure; R⁴ is an alkylene or a hydroxyalkylene group containing 2 to 3 carbon atoms; and n ranges from 0 to about 20.

Amine oxide surfactants can include coconut or tallow alkyl di-(lower alkyl) amine oxides, specific examples of which are dodecyldimethylamine oxide, tridecyldimethylamine oxide, etradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

More preferred are amphoteric surfactants wherein one substituent of the central amine is an aliphatic radical which contains 6 to 11 carbons, or most preferably 8 to 10 carbons, which is either directly attached to the amine or, more preferably, attached to an amidopropyl or alkoxypropyl group which in turn is attached to the amine. Additionally, in the more preferred amphoteric surfactants, one or more substituents of the central amine contain an anionic carboxy group.

Long chain imidazole derivatives having application in the present invention generally have the general formula:

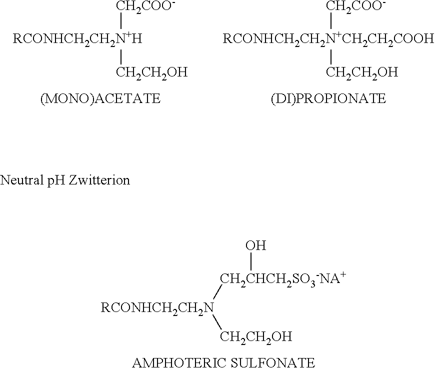

wherein R is an acyclic hydrophobic group containing from about 8 to 18 carbon atoms and M is a cation to neutralize the charge of the anion, generally sodium. Commercially prominent imidazoline-derived amphoterics that can be employed in the present compositions include for example: Cocoamphopropionate, Cocoamphocarboxy-propionate, Cocoamphoglycinate, Cocoamphocarboxy-glycinate, Cocoamphopropyl-sulfonate, and Cocoamphocarboxy-propionic acid. Amphocarboxylic acids can be produced from fatty imidazolines in which the dicarboxylic acid functionality of the amphodicarboxylic acid is diacetic acid and/or dipropionic acid. The carboxymethylated compounds (glycinates) described herein above frequently are called betaines.

Long chain N-alkylamino acids are readily prepared by reaction RNH₂, in which R═C₈-C₁₈ straight or branched chain alkyl, fatty amines with halogenated carboxylic acids. Alkylation of the primary amino groups of an amino acid leads to secondary and tertiary amines. Alkyl substituents may have additional amino groups that provide more than one reactive nitrogen center. Most commercial N-alkylamine acids are alkyl derivatives of beta-alanine or beta-N(2-carboxyethyl) alanine. Examples of commercial N-alkylamino acid ampholytes having application in this invention include alkyl beta-amino dipropionates, RN(C₂H₄COOM)₂ and RNHC₂H₄COOM. In an embodiment, R can be an acyclic hydrophobic group containing from about 8 to about 18 carbon atoms, and M is a cation to neutralize the charge of the anion.

Suitable amphoteric surfactants include those derived from coconut products such as coconut oil or coconut fatty acid. Additional suitable coconut derived surfactants include as part of their structure an ethylenediamine moiety, an alkanolamide moiety, an amino acid moiety, e.g., glycine, or a combination thereof; and an aliphatic substituent of from about 8 to 18 (e.g., 12) carbon atoms. Such a surfactant can also be considered an alkyl amphodicarboxylic acid. These amphoteric surfactants can include chemical structures represented as: C₁₂-alkyl-C(O)—NH—CH₂—CH₂—N⁺(CH₂—CH₂—CO₂Na)₂—CH₂—CH₂—OH or C₁₂-alkyl- C(O)—N(H)—CH₂—CH₂—N+(CH₂—CO₂Na)₂—CH₂—CH₂—OH.

In some embodiments, the surfactant(s) is included in the composition at an amount of at least about 1 wt-% to about 5 wt-%, about 2 wt-% to about 50 wt-%, about 5 wt-% to about 50 wt-%. In addition, without being limited according to the disclosure, all ranges recited are inclusive of the numbers defining the range and include each integer within the defined range.

### Buffers

The liquid cleaning compositions include at least one buffer. In an embodiment, the at least one buffer includes a weak acid. For the purposes of this disclosure, an acid is a component that can be added to an aqueous system and result in a pH less than about 7. “Weak” organic and inorganic acids are acids or acid components in which the first dissociation step of a proton from the acid moiety does not proceed essentially to completion when the acid is dissolved in water at ambient temperatures at a concentration within the range useful to form the present compositions.

Exemplary weak acids suitable for use in the buffer of the liquid cleaning compositions include alpha hydroxycarboxylic acids, such as lactic acid, citric acid, tartaric acid, malic acid, gluconic acid, and the like; carboxylic acids, such as formic acid, acetic acid, propionic acid and the like; other common organic acids such as ascorbic acid, glutamic acid, levulinic acid, etc. In an aspect, the compositions include a weak acid and/or a salt thereof, such as, but not limited to, citrate, acetate, or the like. In a preferred aspect, the compositions include both a weak acid and salt thereof, such as, but not limited to citric acid and a sodium citrate.

In a preferred aspect, the compositions include a weak acid having a pKa greater than about 2.5 to beneficially provide the pH of the concentrate liquid cleaning compositions from about 4.5 to about 10, from about 5 to about 10, from about 5.5 to about 10, or from about 5.5 to about 9, and moreover upon dilution provide the pH of the use solution of the liquid cleaning composition between about 5 to about 8, or between about 5.5 to about 7.

In certain aspects, the compositions include from about 0.5 wt-% to about 20 wt-%, from about 1 wt-% to about 20 wt-%, or from about 1 wt-% to about 15 wt-% of the buffer(s). In addition, without being limited according to the invention, all ranges recited are inclusive of the numbers defining the range and include each integer within the defined range. In some embodiments, the compositions include about 0.5 wt-% to a 20 wt-%, about 0.5 wt-% to a 15 wt-%, or about 0.5 wt-% to a 10 wt-% of a weak acid buffer.

### Water

The liquid compositions include water. In some embodiments, the water is included in the composition at an amount of at least about 30 wt-% to about 80 wt-%, about 40 wt-% to about 75 wt-%, or about 45 wt-% to about 70 wt -%. In addition, without being limited according to the disclosure, all ranges recited are inclusive of the numbers defining the range and include each integer within the defined range.

In embodiments the water provides a liquid composition. It is preferred that the liquid cleaning composition is a pumpable liquid. Beneficially, pumpable liquids can be dispensed through various conventional dispensers, including for example, aspirator-type dispensers. The liquid cleaning composition has a viscosity suitable for dispensing via a pumpable dispenser. In exemplary embodiments, the liquid compositions can have a viscosity range of from about 1 to about 3000 mPas, or from about 1 to about 1500 mPas, at 20° C. measured at 20 revolutions per minute on a Brookfield RVT viscosimeter with spindle #2.

### Additional Functional Ingredients

The components of the liquid cleaning compositions can further be combined with various functional components suitable for uses disclosed herein, including detergency. In some embodiments, the liquid cleaning compositions comprising an amylase enzyme, at least one surfactant, buffer and water make up a large amount, or even substantially all of the total weight of the compositions. For example, in some embodiments few or no additional functional ingredients are disposed therein.

In other embodiments, additional functional ingredients may be included in the liquid cleaning compositions. The functional ingredients provide desired properties and functionalities to the compositions. For the purpose of this application, the term “functional ingredient” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and that a broad variety of other functional ingredients may be used. For example, many of the functional materials discussed below relate to materials used in cleaning. However, other embodiments may include functional ingredients for use in other applications.

In some embodiments, the liquid cleaning compositions may include alkalinity source, defoaming agents (including defoaming surfactants), bleaching agents, dispersants, metal protecting agents, soil antiredeposition agents, stabilizing agents, corrosion inhibitors, penetrants, builders/sequestrants/chelating agents, additional enzymes, aesthetic enhancing agents including fragrances and/or dyes, rheology and/or solubility modifiers or thickeners, hydrotropes or couplers, additional buffers, additional solvents, additional cleaning agents and the like.

In various embodiments, the liquid cleaning compositions are substantially free of phosphates, or preferably free of phosphates.

These additional ingredients can be pre-formulated with the liquid cleaning compositions or added to the concentrate or use solution before, after, or substantially simultaneously with the addition of the compositions. Additionally, the compositions can be used in conjunction with one or more conventional warewashing steps or compositions.

According to embodiments of the disclosure, the various additional functional ingredients may be provided in a composition in the amount from about 0 wt-% and about 40 wt-%, from about 0 wt-% and about 20 wt-%, from about 0 wt-% and about 15 wt-%, from about 0.01 wt-% and about 15 wt-%, from about 0.1 wt-% and about 10 wt-%, or from about 1 wt-% and about 10 wt-%. In addition, without being limited according to the disclosure, all ranges recited are inclusive of the numbers defining the range and include each integer within the defined range.

### Alkalinity Source

The liquid cleaning compositions and methods, according to the present disclosure includes an effective amount of alkaline source. The alkaline source in turn comprises one or more alkaline compounds. The alkaline source can include an alkali metal carbonate, an alkali metal hydroxide, alkaline metal silicate, or a mixture thereof. Suitable metal carbonates that can be used include, for example, sodium or potassium carbonate, bicarbonate, sesquicarbonate, or a mixture thereof. Suitable alkali metal hydroxides that can also be used include, for example, sodium, lithium, or potassium hydroxide. Examples of useful alkaline metal silicates include sodium or potassium silicate (with M₂O:SiO₂ ratio of 2.4 to 5:1, M representing an alkali metal) or metasilicate. The alkaline source may also include a metal borate such as sodium or potassium borate, and the like.

The alkaline source may also include ethanolamines, urea sulfate, amines, amine salts, and quaternary ammonium. The simplest cationic amines, amine salts and quaternary ammonium compounds can be schematically drawn thus:

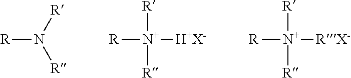

in which, R represents a long alkyl chain, R′, R″, and R″′ may be either long alkyl chains or smaller alkyl or aryl groups or hydrogen and X represents an anion.

The liquid cleaning composition includes an alkalinity source. In some embodiments, the alkalinity source included in the composition may be water soluble ammonia derivatives, including ethanolamine compounds. In specific embodiments, these can include diethanolamine (DEA), triethanolamine (TEA) and monoethanolamine (MEA).

In certain aspects, the compositions include from about 1 wt-% to about 10 wt-%, from about 1 wt-% to about 20 wt-%, or from about 1 wt-% to about 30 wt-% of the buffer(s). In addition, without being limited according to the invention, all ranges recited are inclusive of the numbers defining the range and include each integer within the defined range.

### Methods of Use

The liquid cleaning compositions are particularly well suited for cleaning ware and other hard surfaces and objects soiled with starches and fats, namely oils. The liquid cleaning compositions are efficacious in cleaning and removing soils from such surfaces and objects, including for example oils and starchy soils, including rice starch and chili oil.

The cleaning step includes contacting a ware soiled with the liquid cleaning composition. In some aspects the soiling included starch and fat, for example rice starch and/or chili oil. In some aspects the soiled ware includes soiled dishes, however other soiled surfaces and objects may be contacted with the liquid cleaning composition for cleaning. Ware and other food processing surfaces are particularly well suited for cleaning according to the methods described herein.

The compositions and methods can be used in any cleaning or detergency steps where a heavy starch soil load is in need of cleaning, regardless of whether additional soils are present. Exemplary applications in which the methods and compositions of the present disclosure may be used include, but are not limited to: food and beverage industry or applications, restaurants, including Quick Service Restaurants, catering, home cooking applications and other Consumer Markets, etc.

In some aspects the methods can include a first step of generating a use solution of the liquid cleaning composition before contacting the soiled ware with the use solution of the liquid cleaning composition.

In some aspects, the liquid cleaning compositions are particularly well-suited for a presoak cleaning application. A presoak cleaning step can take place in any vessel or container, including for example wash tanks or vessels, soaking vessels, buckets, holding tanks, sinks, including scrub sinks, or other non-continuous batch washers and systems, and the like. The vessel or container is not intended to be a limiting aspect of the methods described herein as one of ordinary skill in the art will readily ascertain from the disclosure herein.

As referred to herein, presoak refers to a cleaning step that is followed by other cleaning steps. A presoak may or may not be the first step in a cleaning process. In an aspect, a presoak can be used in a cleaning process that includes at least two steps: an initial water washing and/or rinse step and cleaning with the liquid cleaning composition. In another aspect, a presoak can be used in a cleaning process that includes at least three steps: an initial water washing and/or rinse step, cleaning with the liquid cleaning composition, and a further cleaning step (e.g. alkaline and/or acid detergent step). In another aspect, a presoak can be used in a cleaning process that includes at least three steps: an initial water washing and/or rinse step, cleaning with the liquid cleaning composition, and a washing with water and/or rinse step. In still another aspect, a presoak can be used in a cleaning process that includes at least four steps: an initial water washing and/or rinse step, cleaning with the liquid cleaning composition, a further cleaning step (e.g. alkaline and/or acid detergent step), and a final water washing and/or rinse step.

Additional optional steps may include a separate acid or alkaline wash as well as a separate sanitizing step. The strength of the alkaline and acid solutions, the duration of the cleaning steps and the cleaning solution temperature are typically dependent on the amount and tenacity of the soil. The water rinse removes any residual chemical solution and soils prior to the ware being returned for further use.

The liquid cleaning compositions are in contact with a surface or object, namely the ware, for a sufficient amount of time to clean the surface or object. In an aspect, the surface or object is contacted with the liquid cleaning composition for at least about 1 minute, at least about 10 minutes, at least about 20 minutes, at least about 30 minutes, at least about 40 minutes, at least about 1 minute to about 60 minutes.

The temperature of the contacting step can vary between about 40° C. to about 70° C., about 40° ° C. to about 60° C. , or about 40° C. to about 50° C. In various embodiments it is preferred to lower the temperature to 60° C. or below.

The liquid cleaning compositions can be applied at a use or concentrate solution to a surface or object in need of cleaning. In an aspect, a use concentration of the liquid cleaning composition includes from about 100 ppm to about 5,000 ppm, from about 500 ppm to about 5,000 ppm, or from about 1,000 ppm to about 5,000 ppm, including all ranges therebetween.

The liquid cleaning compositions in preferred embodiments can be applied at a use or concentrate solution pH between about 5 to about 11, or between about 5.5 to about 11, or preferably between about 6 to about 11. Additionally, the use or concentrate pH can be between about 5 to about 10, or between about 5.5 to about 10 , or preferably between about 6 to about 10

Beneficially, the methods of cleaning a surface or object in need of cleaning, e.g. ware, effectively removes both starch and oil soils with the liquid cleaning composition including the combination of amylase enzymes for starch removal and surfactants for oil and other soil removal under desired pH conditions based suited for the enzyme performance.

In some aspects, the methods provide the beneficial cleaning efficacy while also reducing at least one of the following: cleaning time, temperature, water consumption and/or cost compared to a liquid cleaning composition that does not include the amylase enzyme and surfactant. In some aspects, the methods of cleaning a surface or object in need of cleaning, e.g. ware, reduces at least two of the following: cleaning time, temperature, water consumption and/or cost compared to a liquid cleaning composition that does not include the amylase enzyme and surfactant. Thus, the compositions and methods of the present disclosure particularly provide an improved cleaning performance.

In additional aspects, the liquid cleaning compositions can also be used in a warewashing application, namely wherein the contacting step is in a ware wash machine. In such aspects the ware wash machine is a consumer or institutional machine. Machines can include dish machines including professional dish washer system such as professional door-/hood-type dish washers or conveyor-/flight-type dish washers and/or in dishwashers with short washing times such as washing times of ≤20min, particularly ≤15 min.

In embodiments where the liquid cleaning composition is formulated for use in a ware wash machine formulation modifications, including use of a defoaming surfactant and/or defoamer may be made.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

The following ingredients are utilized in the Examples:

Enzyme A—Achieve® Shine 100L—an amylase enzyme.

Enzyme B—Amplify Prime—an amylase enzyme.

Barlox® 12—a cocoamine oxide nonionic surfactant.

Tergitol® 15-S-9—a secondary alcohol ethoxylate nonionic surfactant commercially available from Dow Chemical.

Surfonic® L24-7—a7 EO linear primary C12-C14 nonionic surfactant.

Tomadol® 25-3—a3 EO linear primary C12-C15 nonionic surfactant commercially available from Evonik.

Tomadol® 25-9—a 9 EO linear primary C12-C15 nonionic surfactant commercially available from Evonik.

Tomadol® 91-6—a 6 EO linear primary C9-C11 nonionic surfactant commercially available from Evonik.

Plurafac® SLF 180—a nonionic low-foaming surfactant commercially available from BASF.

Linear alkylbenzene sulfonate (LAS)—an anionic surfactant

Aerosol® OT-75-DOSS—a sodium dioctyl sulfosuccinate anionic surfactant commercially available from Solvay.

Ecosurf® SA-9—a nonionic surfactant commercially available from Dow Chemical.

Glucopon® 225—an alkyl polyglycoside nonionic surfactant commercially available from BASF.

Glucopon® 425—an alkyl polyglycoside nonionic surfactant commercially available from BASF.

Glucopon® 600—an alkyl polyglycoside nonionic surfactant commercially available from BASF.

Plurafac® RA300—a nonionic surfactant commercially available from BASF.

APG 225—a C8-C10 fatty alcohol glycoside nonionic surfactant.

Pluronic® 25R2—an EO/PO reverse block copolymer commercially available from BASF.

Softanol® 90—a nonionic surfactant commercially available from ECSA Chemicals.

Additional widely available ingredients such as: glycerin, calcium chloride, trisodium citrate, citric acid, and water.

### Example 1

Various amylase enzymes were evaluated at different temperatures (30° C., 40° C., 50° C., and 60° C) and pH (from 4-11 pH) for cleaning performance against starch soils. The evaluation found that an optimal cleaning range for amylase enzymes was from about 50-60° C. and a pH of from about 4 to 8, about 5 to 7, and preferably about 6.

Further analysis was conducted to evaluate the stability of the amylase enzymes in combination with a citrate buffer system to provide a use pH of 6.5. These amylase and buffer compositions were evaluated at 50° C. initially, and thereafter after 4 hours, 8 hours, and 24 hours, which can be seen in FIG. 1. FIG. 1 shows that the amylase and citrate buffer composition demonstrate effective cleaning ability (as measured by ΔL a quantification of whiteness or decrease of soil on a surface) that only marginally changes from initial use to use after 24 hours in a use solution, demonstrating stability of the amylase in the buffered composition.

The soil and substrate for the cleaning tests in the Examples included DM-78 Rice Starch, baked on melamine tiles from Test Fabrics. First, L values were measured for all rice starch coupons (cut from the tiles). Then, a 1000 mL of a 0.2% solution of the respective formula was made. Once the solutions reached 50° C. in a water bath, the respective enzyme at its use concentration was added along with 4 rice starch coupons. One coupon was removed at 2.5, 5, 7.5, and 10 minutes. Finally, L values were measured again for all rice starch coupons and the data was analyzed.

A cleaning effect of the liquid cleaning composition is demonstrated by an increased lightness value L* of a cleaned surface compared with a soiled surface. L-value is a measurement of the lightness that varies from 100 for perfect white to 0 for black. A delta L-value is calculated by subtracting the ending L* value of the cleaned surface from the starting L* value of the soiled surface. The level of increased lightness value L* may be quantified, if desired. For example, a composition may be characterized as providing an increased lightness value L* when the composition provides a positive delta L-value when measured using a spectrophotometer, such as a MINISCAN XE Plus color spectrophotometer (from Hunter Associates Laboratory).

### Example 2

Commercially available detergents were analyzed for surfactant compatibility and efficacious cleaning of both the starch and oil soils as described in Example 1 with additional method description provided herein. Two commercially available detergents, detergent A and detergent B, were chosen to study the effects of their pH on surfactant compatibility. Commercially available detergent A, a detergent at a pH of approximately 9, comprises a bicarbonate, a phosphate, and an alcohol ethoxylate nonionic surfactant, and commercially available detergent B, a detergent at a pH of approximately 7, comprises TEA, citric acid, a polyacrylic acid, propylene glycol, and glycerin.

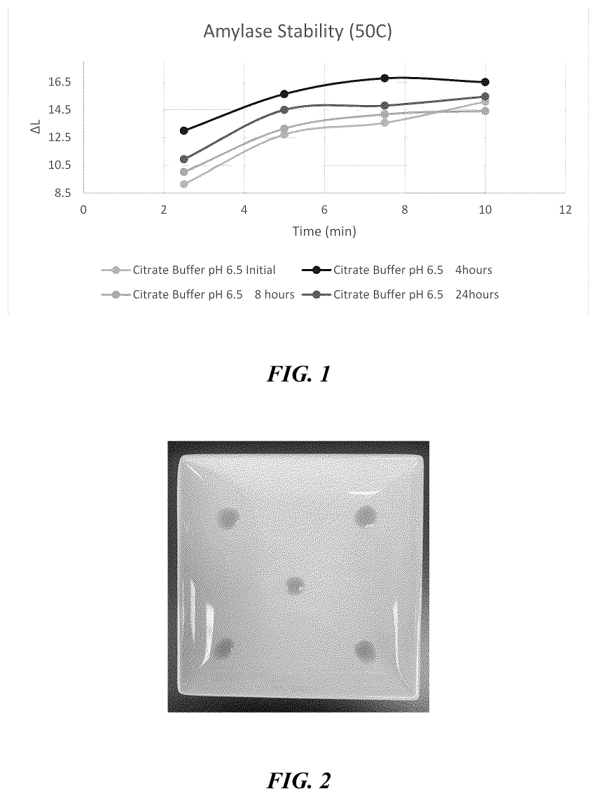

Commercially available detergents A and B were combined with 500 ppm of various surfactants and tested for cleaning performance of chili oil. The detergents were evaluated on the amount of time required for cleaning of chili oil. The test methodology for chili oil cleaning included placing 5 drops of chili oil on a 2-inch by 2-inch melamine plate, as seen in FIG. 2. A water bath of 500 mL was prepared to 40-60° C. The evaluated detergent was then added to the water bath and mixed with a stir bar. Once the water bath reached the desired temperature, the stirring was turned off and the melamine plate was placed into the bath and monitored for chili oil removal. Cleaning time of the various surfactants and commercially available detergents can be seen in Table 2.

TABLE 2

500 ppm Surfactant

| | Detergent A | Detergent B |
|---|---|---|
| | pH 9 | pH 7 |
| Surfactant | time (min) | time (min) |
| Tergitol 15-S-9 | 22 | 30 |
| Surfonic L24-7 | 30 | 30 |
| Tomadol 25-3 + Tomadol 25-9 | 30 | 30 |
| (1:3 ratio) | | |
| Barlox 12 (30% active) | 4.5 | 4 |
| Tomadol 91-6 + LAS | 22 | 30 |
| Aerosol OT-75 (75% active) | 30 | 30 |
| Ecosurf SA-9 | 30 | 30 |
| Glucopon 225 | 13 | 30 |
| Glucopon 425 | 8 | 30 |
| Glucopon 600 | 5 | 30 |
| RA300 | 30 | 30 |

As can be seen in Table 2, many of the surfactants took approximately 30 minutes to remove the chili oil. The amine oxide surfactant Barlox 12 provided a significantly enhanced cleaning rate with both commercially available detergents and at both basic and neutral pH values (pH 9 and pH 7).

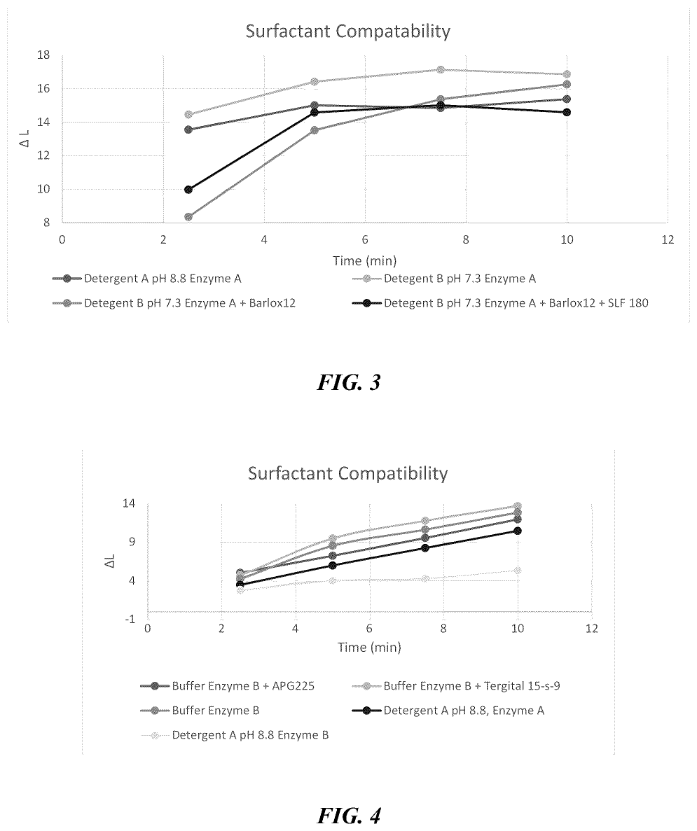

The commercially available detergents A and B were combined with two exemplary amylase enzymes A and B. FIG. 3 shows the compatibility and cleaning performance of commercially available detergent A and B in combination with amylase enzyme A and commercially available detergent B with amylase enzyme A and additional surfactants. As FIG. 3 shows, the commercially available detergent B demonstrated enhanced cleaning performance when combined with the amylase enzyme compared to commercially available detergent A. Without being limited to a particular theory, it is believed that the lower pH of 7 improves the enzymatic and surfactant cleaning performance against the chili oil.

### Example 3

An exemplary buffer was analyzed for effect on surfactant compatibility. Table 3 describes an exemplary buffer, providing a use solution pH of approximately 6.5.

TABLE 3

| Buffer at pH 6.5 | wt % |
|---|---|
| Soft Water | 93.85 |
| Trisodium Citrate | 3.85 |
| Citric acid, 50% | 2.3 |

The exemplary buffer was combined with 50 ppm, 100 ppm, and 200 ppm of surfactants Tergitol 15-S-9 (an alcohol ethoxylate nonionic surfactant) and Barlox 12 (amine oxide) and tested for cleaning performance against chili oil. Liquid cleaning compositions were evaluated on the amount of time required for cleaning of chili oil as described in Example 2. Cleaning time and removal can be seen in Table 4 which was evaluated as described in Example 1, which shows that the amine oxide demonstrated effective cleaning at 100 ppm but had an improved cleaning time at 200 ppm at a pH of 6.5. This also demonstrates that the amine oxide can be effective at a more acidic pH (pH 6.5) and even more effective than at neutral or basic pH values (as shown in Example 2) at less than half the amount (200 ppm vs. 500 ppm).

TABLE 4

| Buffer at pH 6.5 | | |
|---|---|---|
| Surfactant | time (min) | |
| 50 ppm Tergitol 15-S-9 | 1 hr+ (no removal) | |
| 50 ppm Barlox 12 | 1 hr+ (some removal) | |
| 100 ppm Barlox 12 | 1 | hr |
| 200 ppm Barlox 12 | 15 | minutes |

Thereafter detergent A of Example 2 was compared to the exemplary buffer, for surfactant compatibility. Commercially available detergent A was combined with amylase enzyme A and B and the exemplary buffer was further combined with amylase enzyme B and various surfactants, as shown in FIG. 4. FIG. 4 demonstrates that the exemplary buffer and amylase enzyme formulas outperformed the commercially available detergent A. Again, it is believed that the detergent formulas and surfactants show an improved cleaning performance when combined with an enzyme at a lower pH.

### Example 4

Commercially available detergents A and B, as described in Example 2, were compared to exemplary liquid cleaning compositions for cleaning performance of chili oil, the procedure of which is described in Example 2. The liquid cleaning composition is a combination of the exemplary buffer of Example 3, an amylase enzyme and the listed surfactants. Various surfactants at 250 ppm, 200 ppm, 100 ppm, and 50 ppm were combined with the detergents A-C at pH ranging from 9 to 6.5 and cleaning time was assessed. The results can be seen in Table 5.

TABLE 5

| Buffer | Surfactant | Chili Oil Cleaning | |
|---|---|---|---|
| Detergent A (0.5%) pH 9 | 250 ppm Tergitol 15-S-9 | 25 | minutes |
| Detergent A (0.1%) pH 9 | 50 ppm Tergitol 15-S-9 | 1 hour (no | |
| | | removal) | |
| Detergent A (0.5%) pH 9 | 250 ppm APG 225 | 13 | minutes |
| Detergent A (0.5%) pH 9 | 250 ppm Barlox 12 | 4.5 | minutes |
| Detergent B pH 7.3 | 250 ppm APG 225 | 30 | minutes |
| Detergent B pH 7.3 | 250 ppm Barlox 12 | 3.5 | minutes |
| Liquid Cleaning | 50 ppm Barlox 12 | 1 hour (some | |
| Composition pH 6.5 | | removal) | |
| Liquid Cleaning | 100 ppm Barlox 12 | 1 | hour |
| Composition pH 6.5 | | | |
| Liquid Cleaning | 200 ppm Barlox 12 | 15 | minutes |
| Composition pH 6.5 | | | |

As Table 5 demonstrates, as the pH was lowered, and optimized for enzyme cleaning rate, the lower pH impacted surfactant rate of cleaning. It was surprisingly found that amine oxide (Barlox 12) worked very efficiently across a broad pH range for chili oil removal.

### Example 5

Commercially available detergent A was compared to exemplary liquid cleaning composition formulas 3 and 7 for rice starch cleaning performance with varying amylase enzyme concentrations according to the methods described in Example 1. Exemplary liquid cleaning composition formulas 3 and 7 are described in Table 6. Rice starch cleaning performance was evaluated with 0.2 wt-% detergent and the evaluated amount of amylase enzyme were dosed in a use solution.

As shown in FIG. 5, commercially available detergent A was combined with 10 ppm of an amylase enzyme and compared to exemplary liquid cleaning composition formula 3 combined with 2 ppm, 4 ppm, 6 ppm, 8 ppm, and 10 ppm of an amylase enzyme. FIG. 5 shows that exemplary liquid cleaning composition formula 3 outperformed commercially available detergent A regardless of amount of the amylase enzyme.

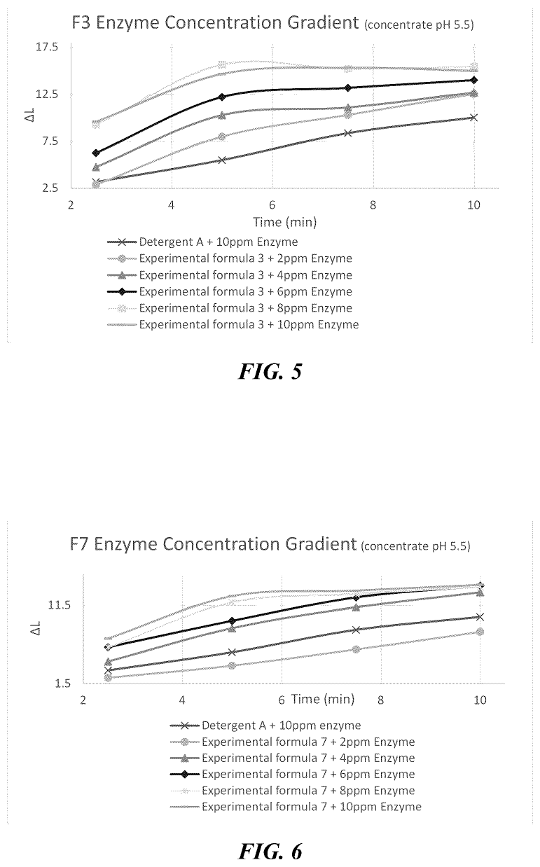

Similarly in FIG. 6, commercially available detergent A was combined with 10 ppm of an amylase enzyme and compared to exemplary liquid cleaning composition formula 7 combined with 2 ppm, 4 ppm, 6 ppm, 8 ppm, and 10 ppm of an amylase enzyme. FIG. 6 shows that unlike exemplary liquid cleaning composition formula 3, the exemplary liquid cleaning composition formula 7 only outperformed the commercially available detergent A when the amylase enzyme is at least 4 ppm.

TABLE 6

| | Formula 3 | Formula 7 |
|---|---|---|
| Description | wt % | wt % |
| Soft water | 45-55 | 60-70 |
| Trisodium Citrate | 3-5 | 3-5 |
| Citric acid, 50% | 2-4 | 2-4 |
| Barlox 12 | 20-40 | 0 |
| APG225 | 0 | 10-20 |
| Pluronic 25R2 | 1-5 | 0 |
| Glycerin | 10-15 | 10-15 |
| Achieve Shine | 1-5 | 1-5 |
| CaCl₂ | <1 | <1 |
| Total | 100 | 100 |
| pH | 5.50 | 5.50 |

### Example 6

An exemplary liquid cleaning composition was tested using a base composition of Formula R13 shown in Table 7. This formula was tested with 3 different preservatives to assess the enzyme stabilization and the cleaning composition effectiveness. Table 7 demonstrates the control set of data, or R13 without a preservative tested.

TABLE 7

| Raw Material # | Percent Concentration |
|---|---|
| Water | 78 |
| TEA | 8 |
| Citric acid, 50% | 0.5 |
| Softanol 90 | 4.5 |
| Glycerine | 7 |
| Achieve Shine 100 L | 2 |
| TOTAL | 100.00% |
| Sterility Control Check: | Sterile |

Formula R13 was tested with three additional preservatives: Sodium Benzoate, Phenoxyethanol and Ethylenediaminetetraacetic acid (EDTA). These preservatives and the formula were tested with five types of bacteria, and two types of yeast and mold according to the testing summarized in Tables 8 and 9. This indicated that the Formula combined with each preservative was effective against the bacteria as well as the yeast and mold.

TABLE 8

Log₁₀ Reduction

| Inoculum | 2 days | 7 days | 14 days | 28 days |
|---|---|---|---|---|
| All bacteria | ≥2.0 | ≥3.0 | — | NI* |
| All Yeast & Mold | — | — | ≥2.0 | NI* |
| All bacteria | — | — | ≥3.0 | NI* |
| All Yeast & Mold | — | — | ≥1.0 | NI* |

— Means no log reduction criteria apply at this time point.
NI* Means no increase in recovered counts as compared to the results obtained at Day 2.

### Example 7

Using the same formula as described in Example 6, R13 was also tested for stability. Table 10 depicts that R13 had a higher total yield when the measured pH was 8.06. Additionally, Table 11 depicts the stability data corresponding to each formula. Columns 4, 5 and 6 correspond to Formulas R13, R13 (pH 8), and R13 (pH 7). Table 11 depicts the effectiveness of each formula after a 2, 4 or 6 week periods with different temperatures: room temperature, 40 degrees Celsius, or 50 degrees Celsius. As both Tables 9 and 10 demonstrate, R13 remains effective with a higher pH.

TABLE 9

| | R9 | | | R13 | R13 (pH 8) | R13 (pH 7) | R3 | R14 |
|---|---|---|---|---|---|---|---|---|
| Description | 1 | 2 | 3 | 4 | 5 | 6 | 10 | 11 |
| Water | 63.8 | 61 | 66.4 | 78 | 75.5 | 72.5 | 66.75 | 69.75 |
| STPP | | | | | | | 8 | 8 |
| TEA | 8 | 8 | 8 | 8 | 8 | 8 | | |
| Citric acid, 50% | 3.28 | 5.96 | 0.56 | 0.52 | 3.26 | 6.12 | 3 | |
| Barlox 12 | 15 | 15 | 15 | | | | 12.25 | 12.25 |
| Pluronic 25R2 | 1.2 | 1.2 | 1.2 | | | | 1 | 1 |
| Softanol 90 | | | | 4.5 | 4.5 | 4.5 | | |
| Tergitol 15-s-7 | | | | | | | | |
| Glycerine | 7 | 7 | 7 | 7 | 7 | 7 | 7 | 7 |
| Propylene glycol | | | | | | | | |
| Achieve Shine 100 L | 2 | 2 | 2 | 2 | 2 | 2 | 2 | 2 |
| CaCl2, 77% | | | | | | | | |
| Total | 100.28 | 100.16 | 100.16 | 100.02 | 100.26 | 100.12 | 100 | 100 |
| Measured pH (conc) | 8.07 | 7.16 | 9.02 | 9.04 | 8.06 | 7.04 | 6.2 | 8.6 |

TABLE 10

| Description | 1 | 2 | 3 | 4 | 5 | 6 | 10 | 11 |
|---|---|---|---|---|---|---|---|---|
| Initial | 100% | 100% | 100% | 100% | 100% | 100% | 100% | 100% |
| 2 wk, RT | 100% | 100% | 100% | 100% | 100% | 99% | 58% | 98% |
| 2 wk, 40 C. | 100% | 70% | 100% | 100% | 93% | 20% | 0% | 39% |
| 2 wk, 50 C. | 76% | 3% | 100% | 100% | 34% | 0% | 0% | 0% |
| 4 wk, RT | 100% | 98% | 100% | 100% | 100% | 91% | 90% | 94% |
| 4 wk, 40 C. | 99% | 45% | 100% | 100% | 86% | 2% | 26% | 16% |
| 4 wk, 50 C. | 53% | 0% | 98% | 100% | 0% | 10% | 0% | 0% |
| 6 wk, RT | 100% | 98% | 100% | 100% | 100% | 94% | 87% | 94% |
| 6 wk, 40 C. | 10% | 29% | 100% | 100% | 82% | 0% | 12% | 8% |
| 6 wk, 50 C. | 40% | 0% | 100% | 99% | 4% | 0% | 0% | 0% |

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure. All publications discussed and/or referenced herein are incorporated herein in their entirety.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

1. A liquid cleaning composition comprising:
an amylase enzyme;
at least one surfactant;
a buffer; and
water;
wherein the liquid composition is a concentrate having a pH from about 4 to about 11.

2. The composition of claim 1, wherein the amylase is selected for enhanced starch and oil removal at a use pH from about 5 to 10.

3. The composition of claim 1, wherein the surfactant comprises an amphoteric and/or nonionic surfactant.

4. The composition of claim 3, wherein the surfactant comprises at least one of an amine oxide, alkyl polyglycoside, EO/PO block copolymers, a C12-C14 secondary alcohol, an alkylene oxide or combination thereof.

5. The composition of claim 3, wherein the surfactant comprises at least two of an amine oxide, alkyl polyglycoside, EO/PO block copolymers, a C12-C14 secondary alcohol, an alkylene oxide or combination thereof.

6. The composition of claim 1, wherein the buffer comprises a weak acid, a salt of a weak acid, or a combination thereof.

7. The composition of claim 1, wherein the pH of the concentrate composition is from about 4.5 to about 11.

8. The composition of claim 1, wherein the composition comprises from about 0.1 wt-% to about 5 wt-% amylase enzyme, from about 2 wt-% to about 40 wt-% surfactant(s), from about 0.5 wt-% to about 20 wt-% buffer, and from about 30 wt-% to about 80 wt-% water.

9. The composition of claim 1, further comprising at least one additional functional ingredient comprising an alkalinity source, defoaming agent, bleaching agent, dispersants, metal protecting agents, soil antiredeposition agents, stabilizing agents, corrosion inhibitors, builders/sequestrants/chelating agents, additional enzymes, aesthetic enhancing agents including fragrances and/or dyes, rheology and/or solubility modifiers or thickeners, hydrotropes or couplers, additional buffers, additional solvents, and/or additional cleaning agents.

10. The composition of claim 1, further comprising a solvent.

11. A method of use comprising:
contacting a ware soiled with starch and fat with the liquid cleaning composition according to claim 1; and
removing said soils from the ware.

12. The method of claim 11, wherein the soils comprising starch and fats include at least one of rice starch and/or chili oil.

13. The method of claim 11, further comprising a first step of generating a use solution of the liquid cleaning composition before contacting the soiled ware with the use solution of the liquid cleaning composition.

14. The method of claim 13, wherein the use solution provides from about 100 ppm to about 5,000 ppm of the liquid cleaning composition.

15. The method of claim 11, wherein the contacting step is at a pH between about 5 to about 8, or between about 5.5 to about 10.

16. The method of claim 11, wherein the contacting step is at least about 10 minutes, or at least about 1 minute to about 60 minutes.

17. The method of claim 11, wherein the temperature of the contacting step is between about 40° C. to about 70° C.

18. The method of claim 11, wherein the method reduces at least one of the cleaning time, temperature, water consumption and/or cost compared to a liquid cleaning composition that does not include the amylase enzyme and surfactant.

19. The method of claim 11, wherein the contacting step is a presoak application.

20. The method of claim 11, wherein the contacting step is in a consumer or institutional ware wash machine.

21. (canceled)
